(19) United States
(12) Patent Application Publication
(10) Pub. No.: US 2007/0220234 A1
(43) Pub. Date: Sep. 20, 2007

(54) Autonomous multi-microcontroller system and the control method thereof

(76) Inventors: Jung Lin Chang, Hsin-Chu (TW); Chuan Po Ling, Hsin-Chu (TW); Shih Yu Lin, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/376,234

(22) Filed: Mar. 16, 2006

(51) Int. Cl. G06F 15/00

(52) U.S. Cl. 712/34

(57) ABSTRACT

The present invention discloses an autonomous multi-microcontroller system and the control method thereof, wherein any MCU core logic of the multi-microcontroller system can directly place the starting address of an inserted program into the program counter of a controllee MCU core logic. The address of the interrupted program of the controllee MCU core logic is temporarily stored in the stack memory according to the index of the stack pointer of the MCU core logic so that the controllee MCU core logic can resume execution of the interrupted program after it has completed execution of the inserted program.

### BACKGROUND OF THE INVENTION

1. Field of the Invention

The present invention relates to a multi-microcontroller system and the control method thereof, particularly to an autonomous multi-microcontroller system and the control method thereof.

2. Description of the Related Art

A microcontroller/microprocessor (MCU/MPU), which is also called a single-chip microcomputer, is an integrated circuit issuing control commands in a system. It can operate without the assistance from any other auxiliary circuit. A microcontroller provides the functions almost in equivalent to that provided by a miniature computer. In recent years, microcontrollers are widely applied to many fields, such as consumer electronic products, industrial controllers, medical equipments, vehicle controllers, and so on. According to the field applied to, a microcontroller may have a different specification and may cooperate with different peripheral devices.

The development history of microcontrollers is a story of continuous improvement of three targets: (1) acceleration of data processing speed, (2) miniature of chip size per unit function, and (3) reduction of power consumption. Many important advancements of microcontrollers have thus been made, including: increase of the number of processed bits, faster clock frequency, improvement of arithmetic units, better memory management, cache technology, pipeline processing architectures, pre-decoding and pre-execution of instructions, new instruction sets for multimedia, new fabrication processes, and new packaging technologies. Nevertheless, all the abovementioned achievements are attributed to the improvement of two key technologies: the semiconductor process technology and the hardware architecture design technology. The advancements in the semiconductor process technology increase the number of transistors per chip and reduce the distances between devices, so that operation voltage can be lowered, operation speed can be increased, and more advanced functions can be provided. The advancements in the hardware architecture design include: the super-pipeline architecture, the internal cache architecture, the super-scalar technology, the predictive execution technology, and the microcode trace technology. Of the above, the pipeline technology is the most important contributor to the improvement of hardware architecture design technology. The pipeline technology performs task partition, which divides a task into multiple parts and allocates it to multiple units. Even if the clock frequency of a microcontroller cannot be increased, the execution speed of a microcontroller may still be increased due to such pipeline technology.

A conventional multi-microcontroller system and a conventional hyper-thread microcontroller system performing task-partition function are shown in the block diagrams of FIG. 1(a) and FIG. 1(b). The conventional multi-microcontroller system (FIG. 1(a)) comprises essentially multiple microcontrollers 10, 11, and 12, which are coupled to a common data memory 13 and common peripheral devices 14 via buses (illustrated by the hollow double arrows). Each of the MCUs (Microcontrollers) includes a core logic 102, 112, and 122 which cooperates respectively with a corresponding program memory 101, 111, and 121. The MCUs operate mutually independently.

The conventional hyper-thread microcontroller system (FIG. 1(b)) comprises essentially multiple microcontroller core units 15 and 16. Each of the microcontroller core units 15 and 16 includes a MCU core logic (152 and 162), and a corresponding dedicated instruction buffer (151 and 161). The MCU core units 15 and 16 are respectively coupled to a data memory 18 and a program memory 17 via buses (shown by the hollow double arrows). By this arrangement of the instruction buffers, the MCU units can parallelly and separately execute corresponding programs, so that each MCU less accesses the program memory 17. Thus, the probability that the microcontroller core units interfere with each other during accessing the program memory 17 is greatly reduced, and the programs can be executed more effectively.

In either the conventional multi-microcontroller system or the conventional hyper-thread microcontroller system, their program execution operation in response to an interrupt request are the same. Referring to FIG. 2, since every microcontroller operates independently from any other MCU, when an interruption occurs, the interrupting task has to wait until one of the MCUs is able to detect and respond to the interruption. Assuming an MCU having an MCU core logic 20 is the responding MCU to the interruption. When the MCU core logic 20 detects an interrupt request, the MCU core logic 20 will first put the content of its own program counter 24 into a stack memory 26, and next obtain the starting address of an ISR (Interrupt Service Routine) so as to execute the interrupting task. As seen from the above, in those two conventional multi-microcontroller systems, the microcontrollers cannot directly and effectively control one another. One microcontroller (not shown in FIG. 2) can only “inform” another microcontroller (such as the MCU having the core logic 20), by setting up a flag or sending an interrupt request to the latter, that the program the latter is executing should be changed. Thereafter, the former MCU has to wait for the latter MCU to respond. In such case, the tasks may be inappropriately distributed to the microcontrollers, and the overall performance of the entire multi-microcontroller system may be degraded. Besides the incapability of direct and effective inter-control, the interruption action is also time-consuming in such an operation mode. Therefore, It is hard for such conventional technology to meet higher and more complex requirements of advanced electronic products.

Accordingly, the present invention proposes an autonomous multi-microcontroller system and the control method thereof to overcome the problems mentioned above, wherein the microcontroller units of a multi-microcontroller system can effectively inter-control one another, and the starting address of the interrupting (inserted) program can be directly placed into the controllee microcontroller unit so that the time required for interruption action can be shortened, and thus each microcontroller unit can achieve the best performance.

### SUMMARY OF THE INVENTION

The primary objective of the present invention is to provide an autonomous multi-microcontroller system, wherein multiple MCU (Microcontroller) core logics are used to parallelly execute multiple programs, and the operation of each MCU core logic is precisely and effectively controlled via software so that each MCU core logic of the multi-microcontroller system can achieve the best efficacy.

Another objective of the present invention is to provide an autonomous multi-microcontroller system and the control method thereof, wherein according to the instruction from a controller MCU core logic, the starting address of an inserted program is sent to the program counter of a controllee MCU core logic, so that the controllee MCU core logic may instantly execute the inserted program, and thereby, the required interaction time between microcontrollers is minimized.

To achieve the abovementioned objectives, the present invention proposes an autonomous multi-microcontroller system, which comprises: a multi-microcontroller unit, including a plurality of MCU (Microcontroller) functional logics, and a corresponding plurality of program counters respectively coupled to said MCU functional logics for providing a program address to said MCU functional logics; a microcontroller-enable register, coupled to said multi-microcontroller unit, for enabling or disabling said MCU functional logics; and at least one memory, coupled to said multi-microcontroller unit, for storing a program required by said multi-microcontroller unit; wherein each of said MCU functional logics is capable of changing the content of any of said program counters.

In addition, the present invention also proposes a control method for a autonomous multi-microcontroller system, the system having at least a controller MCU (Microcontroller Unit) functional logic, a controllee MCU functional logic, a program counter corresponding to said controllee MCU, and a memory, the method comprising the following steps: disabling said controllee MCU functional logic; freezing said program counter; transferring the content in a location of said memory into said program counter; and enabling said controllee MCU functional logic.

Furthermore, the present invention also proposes a control method for a autonomous multi-microcontroller system, the system having at least a controller MCU (Microcontroller Unit) functional logic, a controllee MCU functional logic, a program counter corresponding to said controllee MCU, a program memory, a stack memory, and a stack pointer corresponding to said stack memory, the method comprising the following steps: disabling said controllee MCU functional logic; freezing said program counter; storing the content of said program counter into a first location of said stack memory according to a first index of said stack pointer; temporarily storing an address of said program memory into a second location of said stack memory according to a second index of said stack pointer; storing the content in said second location of said stack memory into said program counter according to said second index of said stack pointer; enabling said controllee MCU functional logic whereby said controllee MCU functional logic completes the task corresponding to the content in said address of said program memory; disabling said controllee MCU functional logic; restoring the content in said second location of said stack memory into said program counter; and enabling said controllee MCU functional logic whereby said controllee MCU functional logic resumes its original task.

For better understanding of the objectives, technical contents, characteristics, and efficacies of the present invention, the present invention are to be described below in details by illustrative embodiments with reference to the attached drawings.

### BRIEF DESCRIPTION OF THE DRAWINGS

FIG. 1(a) is a block diagram schematically showing the architecture of the conventional multi-microcontroller system.

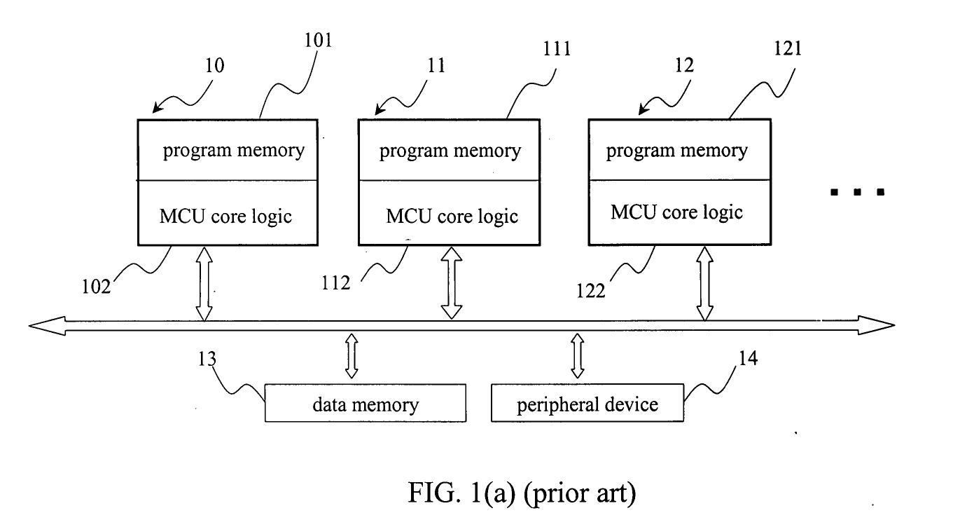

FIG. 1(b) is a block diagram schematically showing the architecture of the conventional hyper-thread microcontroller system.

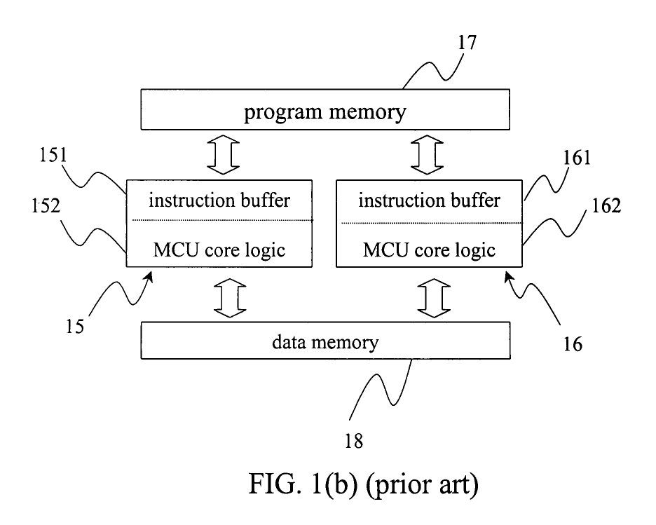

FIG. 2 is a block diagram schematically showing the architecture of the conventional microcontroller system for the operation when an interrupt request occurs.

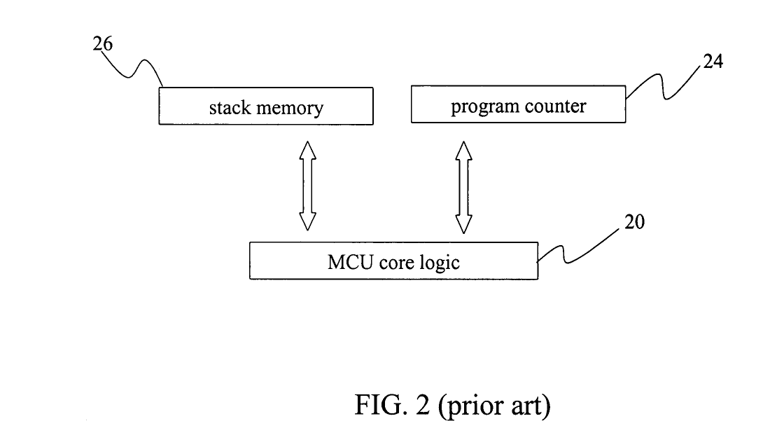

FIG. 3 is a block diagram schematically showing the architecture of the autonomous multi-microcontroller system according to this invention.

FIG. 4 is a flowchart according to a first embodiment of the present invention.

FIG. 5 is a flowchart according to a second embodiment of the present invention.

### DETAILED DESCRIPTION OF THE INVENTION

The present invention is based on the architecture of a multi-microcontroller system wherein each MCU (Microcontroller) core logic can independently execute its program. According to the present invention, during execution of its respective program, each MCU core logic can input the starting address of an assigned program to the program counter of another MCU core logic to determine the next task for the latter MCU core logic (controllee MCU core logic). Thereby, the time required for changing programs of the MCU core logic is minimized.

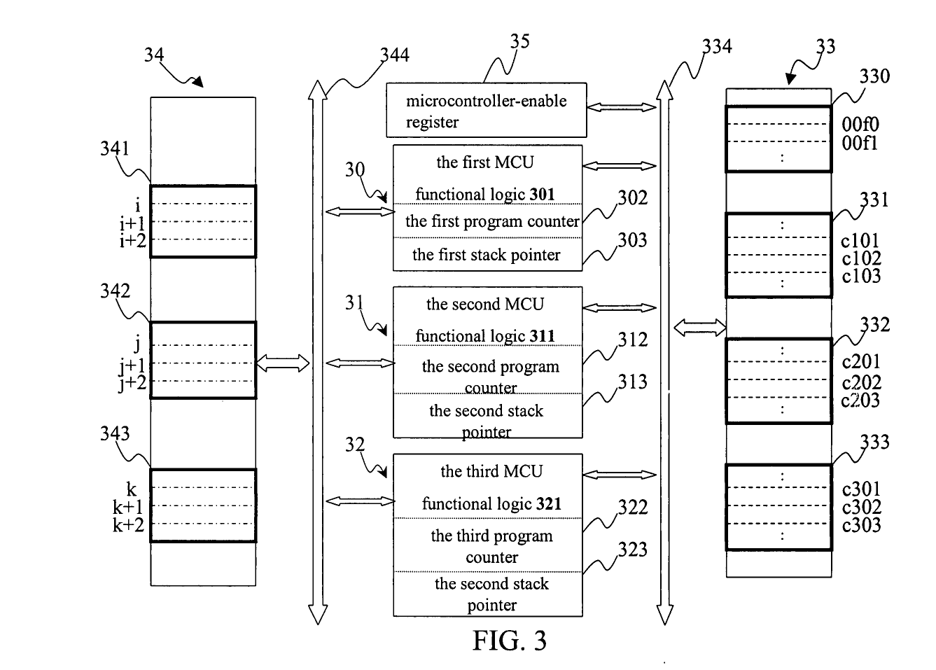

As an example, a first embodiment of the present invention will be described to explain how the system and method work when one MCU core logic of the autonomous multi-microcontroller system intends to control an unspecified (i.e., any other) MCU core logic of the same system. Referring to FIG. 3, the autonomous multi-microcontroller system of the present invention comprises: three MCU core logics 30, 31, and 32; a microcontroller-enable register 35; a program memory 33; and a stack memory 34. The MCU core logics 30, 31, and 32 respectively include functional logics 301, 302 and 303; program counters 302, 312, and 322; and stack pointers 303, 313, and 323. The MCU core logics 30, 31, and 32 are linked to the program memory 33 via a program memory bus 334; thereby, the MCU core logics 30, 31, and 32 can access the the program memory 33 to retrieve programs and instructions stored in the system program block 330 and the first, second and third MCU core logic program blocks 331, 332, and 333. The MCU core logics 30, 31, and 32 are also linked to the stack memory 34 via a stack memory bus 344; thereby, when the MCU core logics 30, 31, and 32 execute programs, the contents of the first, second and third program counters 302, 312, and 322 can be temporarily stored in the corresponding first, second and third MCU core logic stack blocks 341, 342, and 343 separately.

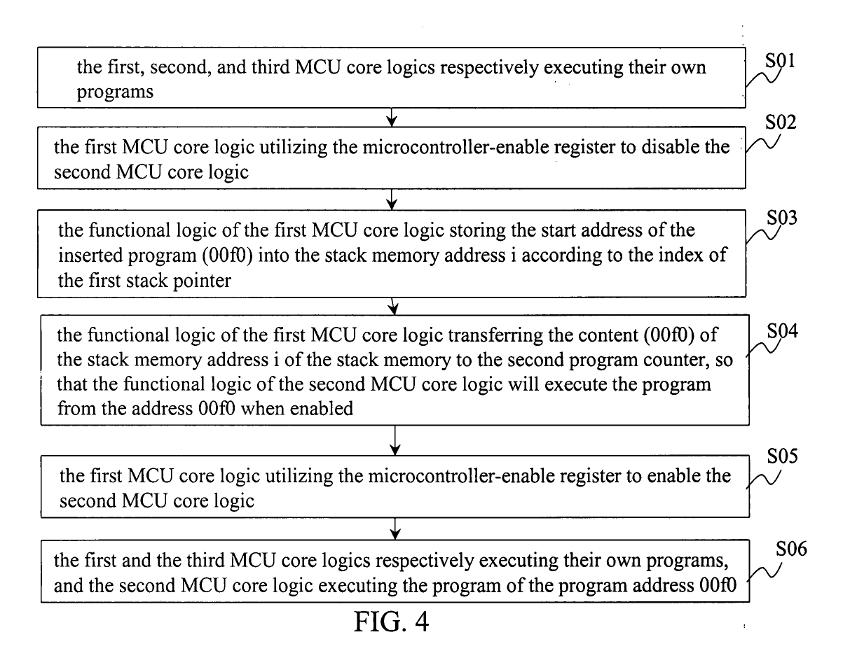

The control method of the autonomous multi-microcontroller system of the present invention will be described in details below. Please refer to FIG. 3 and FIG. 4, wherein FIG. 4 is a flowchart of the control method according to the first embodiment of the present invention. First, in Step S01, the three MCU core logics 30, 31, and 32 respectively execute their own programs. To be more illustrative, let us assume the functional logic 301 of the first MCU core logic 30 is executing the instruction in the program address pointed to by the first program counter 302, and the program address is c101 of the program memory 33; the functional logic 311 of the second MCU core logic 31 is executing the instruction in the program address pointed to by the second program counter 312, and the program address is c201 of the program memory 33; and the functional logic 321 of the third MCU core logic 32 is executing the instruction in the program address pointed to by the third program counter 322, and the program address is c301 of the program memory 33. Next, an interruption occurs which requests the system to execute a program starting from the program address 00f0. The program addresses of this inserted program have been stored in, e.g., the system program block 330. The interruption requires the second MCU core logic 31 to stop its current program of the second MCU core logic program block 332, and execute the inserted system program with the starting address 00f0. Assuming that the functional logic 311 of the second MCU core logic 31 is not required to resume execution of its original program, the original program will be stopped at its present program address (for example, c202), and the second program counter 312 will be correspondingly frozen at the address c202. In Step S02, the first MCU core logic 30 cooperates with the microcontroller-enable register 35 to send a disable signal to the second MCU core logic 31 (and thus to its functional logic 311), stopping the execution of the current program and freeze the program counter 312 at the program address c202. In Step S03, as the index of the first stack pointer 303 of the first MCU core logic 30 is at the stack memory address i, and the starting address of the inserted program, which is to be executed by the functional logic 311 of the controllee second MCU core logic 31, is 00f0, the functional logic 301 of the first MCU core logic 30 stores 00f0 into the stack memory address i of the stack memory 34. In Step S04, the functional logic 301 of the first MCU core logic 30 transfers (by, for example, a Pop instruction such as pop PC2) the content of the stack memory address i of the stack memory 34 (i.e. 00f0) to the second program counter 312 of the second MCU 31; thus, when the second MCU core logic 31 is later enabled, it will execute the program from the address 00f0. In Step S05, the first MCU core logic 30 cooperates with the microcontroller-enable register 35 to send an enable signal to the second MCU core logic 31 (and thus to its functional logic 311), so that the functional logic 311 of the second MCU core logic 31 can start to execute the inserted program with the starting program address 00f0 pointed to by the second program counter 312. In Step S06, since the content of the second program counter 312 of the second MCU 31 has been changed to 00f0, the status of the three MCU core logics 30, 31, and 32 is as follows: the functional logic 301 of the first MCU core logic 30 is still executing the program in the program address pointed to by the first program counter 302, and the program address is at the first MCU core logic program block 331 of the program memory 33; the functional logic 311 of the second MCU core logic 31 is executing the program in the program address pointed to by the second program counter 312, but the program address is at the system program block 330 of the program memory 33; and the functional logic 321 of the third MCU core logic 321 is still executing the program in the program address pointed to by the third program counter 322, and the program address is at the third MCU core logic program block 333 of the program memory 33.

The abovementioned first embodiment has explained the inter-control method for the controller MCU core logic (30) and the controllee MCU core logic (31) in details. In this first embodiment, after the controllee MCU core logic completes the execution of the inserted program, the controllee MCU core logic may start executing a new program, or resume executing the interrupted program. The following second embodiment of the present invention further describes how the system works when the controllee MCU core logic needs to resume the execution of the interrupted program after it has completed execution of the inserted program.

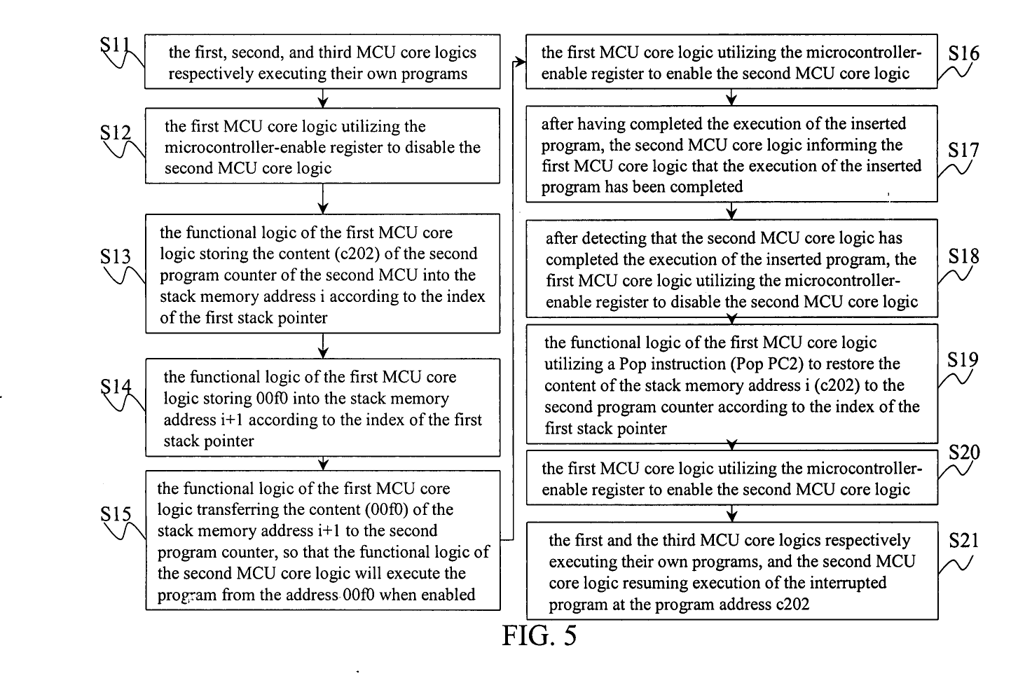

Please refer to FIG. 3 and FIG. 5, wherein FIG. 5 is a flowchart of the control method according to the second embodiment of the present invention. The architecture of the autonomous multi-microcontroller system of the present invention has been described above and is not repeated here. The control method of the autonomous multi-microcontroller system according to the second embodiment of the present invention is now described in details below. First, in Step S11, the three MCU core logics 30, 31, and 32 respectively execute their own programs, i.e. the functional logic 301 of the first MCU core logic 30 is executing the instruction at the program address pointed to by the first program counter 302, and the instruction is at the first MCU core logic program block 331 of the program memory 33; the functional logic 311 of the second MCU core logic 31 is executing the instruction at the program address pointed to by the second program counter 312, and the instruction is at the second MCU core logic program block 332 of the program memory 33; and the functional logic 321 of the third MCU core logic 32 is executing the instruction in the program address pointed to by the third program counter 322, and the instruction is at the third MCU core logic program block 333 of the program memory 33. Next, an interruption occurs which requests the system to execute a program starting from the program address 00f0 which is now stored in the system program block 330. This requires the second MCU core logic 31 to stop its current program of the second MCU core logic program block 332, and execute the inserted system program with the starting address 00f0; in addition, the second MCU core logic 31 will have to resume execution of its original program after completion of the inserted system program. In Step S12, the first MCU core logic 30 cooperates with the microcontroller-enable register 35 to send a disable signal to the second MCU core logic 31 (and thus to its functional logic 311), stopping the execution of the current program and freeze the program counter 312 at the present program address (for example, c202). In Step S13, as the index of the first stack pointer 303 of the first MCU core logic 30 is at the stack memory address i, the functional logic 301 of the first MCU core logic 30 stores (by, for example, a Push instruction such as Push PC2) the content of the second program counter 312 of the second MCU core logic 311 into the stack memory address i. In Step S14, as the index of the first stack pointer 303 of the first MCU core logic 30 is now at the stack memory address i+1, and the starting address of the inserted program, which is to be executed by the controllee second MCU core logic 31, is 00f0, the functional logic 301 of the first MCU core logic 30 stores 00f0 into the stack memory address i+1 of the stack memory 34. In Step S15, the functional logic 301 of the first MCU core logic 30 transfers (by, for example, a Pop instruction such as pop PC2) the content of the stack memory address i+1 of the stack memory 34 (i.e. 00f0) to the second program counter 312 of the second MCU core logic 31. In Step S16, the first MCU core logic 30 cooperates with the microcontroller-enable register 35 to send an enable signal to the second MCU core logic 31 (and thus to its functional logic 311), so that the functional logic 311 of the second MCU core logic 31 can start to execute the inserted system program with the starting address 00f0 pointed to by the second program counter 312. In Step S17, after having completed the execution of the inserted program with the starting address 00f0, the second MCU core logic 31 informs the first MCU core logic 30 that the execution of the inserted program has been completed. In Step S18, in cooperation with the microcontroller-enable register 35, the first MCU core logic 30 sends a disable signal to pause the second MCU core logic 31 and stop its execution of the current program. In Step S19, according to the index of the first stack pointer 303 of the first MCU core logic 30, the functional logic 301 of the first MCU core logic 30 restores (by, for example, a Pop instruction such as Pop PC2) the content (i.e. c202) of the stack memory address i of the stack memory 34 to the second program counter 312 of the second MCU core logic 31, and it means that the second program counter 312 of the second MCU core logic 31 now points to the program memory address c202 of the program memory 33 again. In Step S20, the first MCU core logic 30 cooperates with the microcontroller-enable register 35 to send an enable signal to the second MCU core logic 31, enabling the functional logic 311 of the second MCU core logic 31 to resume the interrupted program stored in the second MCU core logic program block 332 according to the program address pointed to by the second program counter 312. Last, in Step S21, as the second program counter 312 of the second MCU core logic 31 has pointed to the program memory address c202 of the program memory 33 again, the status of the three MCU core logics 30, 31, and 32 is as follows: the functional logic 301 of the first MCU core logic 30 is still executing the program in the program address pointed to by the first program counter 302, and the program address is at the first MCU core logic program block 331 of the program memory 33; the functional logic 311 of the second MCU core logic 31 has resumed execution of its original program, i.e., the program at the program address pointed to by the second program counter 312, and the program address is at the second MCU core logic program block 332 of the program memory 33; and the functional logic 321 of the third MCU core logic 32 is still executing the program in the program address pointed to by the third program counter 322, and the program address is at the third MCU core logic program block 333 of the program memory 33.

It should be noted that in the foregoing embodiments, the first MCU core logic is described as the controller MCU core logic; however, anyone of the MCU core logics may act as the controller MCU core logic to put the starting address of an inserted program into the program counter of a controllee MCU core logic.

And, although it is shown in FIG. 3 that an MCU functional logic, a program counter and a stack pointer together compose an MCU core logic, this is only for easier understanding of the architecture of the present invention. In fact, each of the MCU functional logics may have a dynamic correspondence with one of the program counters and one of the stack pointers.

In addition, in the foregoing embodiments, the program addresses of the inserted program are stored in the system program block 330. However, as a person skilled in this art may readily understand, the program addresses of the inserted program may be stored in any suitable location, such as in a general register. The system program block 330 described herein is only an example.

Furthermore, in the foregoing embodiments, the program addresses are transferred from and to the controllee MCU core logic (the second MCU core logic 31 in the embodiments) by means of a stack memory, together with the use of the stack pointer of the controller MCU core logic (the first MCU core logic 30). However, a person skilled in this art may readily think of many equivalent approaches to achieve the same purpose. For example, the program addresses may be transferred from and to any other memory location, such as a general register, a data memory, or any other memory. Likely, the use of a Push instruction or Pop instruction is not the only way to transfer the program addresses among the memory locations; there are many equivalent ways to do the same, such as by means of a Move instruction, a Call instruction, a Return instruction, by Load Table operation, and so on.

As compared with the conventional technology, the present invention directly changes the content of the program counter of the controllee MCU, and hence it is not required for the controller MCU to set up a flag and wait for the controllee MCU to respond; the waste of several or even several tens of clock cycles of time may thus be saved. Therefore, what the present invention discloses is a simple, effective, and fast-response autonomous multi-microcontroller system and control method.

The embodiments described above are for illustration only, in order for a person skilled in the art to understand the present invention. The embodiments are by no means intended to limit the scope of the present invention. Any modification and variation under the spirit of the present invention should be included in the claimed scope of the present invention.

What is claimed is:

1. An autonomous multi-microcontroller system, comprising:
a multi-microcontroller unit, including a plurality of MCU (Microcontroller) functional logics, and a corresponding plurality of program counters respectively coupled to said MCU functional logics for providing a program address to said MCU functional logics;
a microcontroller-enable register, coupled to said multi-microcontroller unit, for enabling or disabling said MCU functional logics; and
at least one memory, coupled to said multi-microcontroller unit, for storing a program required by said multi-microcontroller unit;
wherein each of said MCU functional logics is capable of changing the content of any of said program counters.

2. The autonomous multi-microcontroller system according to claim 1, wherein each of said MCU functional logics can independently execute at least one program and can simultaneously execute an instruction to control another of said MCU functional logics.

3. The autonomous multi-microcontroller system according to claim 2, wherein said instruction is one selected from the group consisting of: enabling said another MCU functional logic; disabling said another MCU functional logic; transferring a program address into a program counter corresponding to said another MCU functional logic; and transferring the content of a program counter corresponding to said another MCU functional logic to said at least one memory.

4. The autonomous multi-microcontroller system according to claim 1, wherein said at least one memory includes:
at least one program memory, coupled to said multi-microcontroller unit via a program memory bus, and having a plurality of program memory addresses for storing at least one program; and
at least one stack memory, coupled to said multi-microcontroller unit via a stack memory bus, and having a plurality of stack memory addresses for storing at least one program address of a program executed by said multi-microcontroller unit; and
wherein said multi-microcontroller unit further includes:
a plurality of stack pointers respectively coupled to said MCU functional logics for providing a stack memory address.

5. The autonomous multi-microcontroller system according to claim 3, wherein said instruction of transferring the content of a program counter corresponding to said another MCU functional logic to said at least one memory is one selected from the group consisting of: a Push instruction, and a Move instruction.

6. The autonomous multi-microcontroller system according to claim 3, wherein said instruction of transferring a program address into a program counter corresponding to said another MCU functional logic is one selected from the group consisting of: a Pop instruction, a Move instruction, a Call instruction, a return instruction, and a Load Table operation.

7. A Push control method for a multi-microcontroller system having at least a controller MCU (Microcontroller Unit) functional logic, a controllee MCU functional logic, a program counter corresponding to said controllee MCU, and a memory location, the method comprising the following the steps:
said controller MCU functional logic issuing a Push instruction; and
said system storing the content of said program counter corresponding to said controllee MCU functional logic into a memory location.

8. A Pop control method for a multi-microcontroller system having at least a controller MCU (Microcontroller Unit) functional logic, a controllee MCU functional logic, a program counter corresponding to said controllee MCU, and a memory location, the method comprising the following steps:
said controller MCU functional logic issuing a Pop instruction; and
said system interposing a program address into said program counter corresponding to said controllee MCU functional logic.

9. A control method for a multi-microcontroller system having at least a controller MCU (Microcontroller Unit) functional logic, a controllee MCU functional logic, a program counter corresponding to said controllee MCU, and a memory, the method comprising the following steps:
disabling said controllee MCU functional logic;
freezing said program counter;
transferring the content in a first location of said memory into said program counter; and
enabling said controllee MCU functional logic.

10. The control method according to claim 9, wherein said steps of enabling and disabling said controllee MCU functional logic are done by means of a microcontroller-enable register.

11. The control method according to claim 9, further comprising the step of:
before transferring the content in a first location of said memory into said program counter, storing the content of said program counter into a second location of said memory.

12. The control method according to claim 11, further comprising the step of:
after enabling said controllee MCU functional logic whereby said controllee MCU functional logic completes the task corresponding to the content in said first location of said memory, restoring the content in said second location of said memory into said program counter.

13. The control method according to claim 9, wherein said step of transferring the content in a first location of said memory into said program counter is one selected from the group consisting of: a Pop instruction, a Move instruction, a Call instruction, and a Load Table operation.

14. The control method according to claim 11, wherein said step of storing the content of said program counter into a second location of said memory is one selected from the group consisting of: a Push instruction, and a Move instruction.

15. The control method according to claim 12, wherein said step of restoring the content in said second location of said memory into said program counter is one selected from the group consisting of: a Pop instruction, a Move instruction, a Call instruction, a Return instruction, and a Load Table operation.

16. The control method according to claim 9, wherein said first location of said memory is a location in a program memory.

17. The control method according to claim 11, wherein said second location of said memory is a location in a stack memory.

18. The control method according to claim 17, wherein said system further includes a stack pointer corresponding to said stack memory, and wherein said step of storing the content of said program counter into a second location of said memory comprises the step of:
storing the content of said program counter into a location of said stack memory according to the index of said stack pointer.

19. The control method according to claim 16, wherein said system further includes a stack memory and a stack pointer corresponding to said stack memory, and wherein said step of transferring the content in a first location of said memory into said program counter comprises the step of:
temporarily storing the content in a first location of said memory into a location of said stack memory according to a first index of said stack pointer; and
storing the content in said location of said stack memory into said program counter according to a second index of said stack pointer.

20. A control method for a multi-microcontroller system having at least a controller MCU (Microcontroller Unit) functional logic, a controllee MCU functional logic, a program counter corresponding to said controllee MCU, a program memory, a stack memory, and a stack pointer corresponding to said stack memory, the method comprising the following steps:
disabling said controllee MCU functional logic;
freezing said program counter;
storing the content of said program counter into a first location of said stack memory according to a first index of said stack pointer;
temporarily storing an address of said program memory into a second location of said stack memory according to a second index of said stack pointer;
storing the content in said second location of said stack memory into said program counter according to said second index of said stack pointer;
enabling said controllee MCU functional logic whereby said controllee MCU functional logic completes the task corresponding to the content in said address of said program memory;
disabling said controllee MCU functional logic;
restoring the content in said second location of said stack memory into said program counter; and
enabling said controllee MCU functional logic whereby said controllee MCU functional logic resumes its original task.
